(19) United States
(12) Patent Application Publication
(10) Pub. No.: US 2004/0017190 A1
(43) Pub. Date: Jan. 29, 2004

(54) Apparatus and method for absolute angular position sensing

(76) Inventors: Graham F. McDearmon, North Canton, OH (US); Orestes J. Varonis, North Canton, OH (US); Wayne V. Denny, Alliance, OH (US); Raymond A. Severyn, Medina, OH (US)

Correspondence Address: POLSTER, LIEDER, WOODRUFF & LUCCHESI, 763 SOUTH NEW BALLAS ROAD, ST. LOUIS, MO, 63141-8750, US

(21) Appl. No.: 10/621,811

(22) Filed: Jul. 17, 2003

Related U.S. Application Data
(60) Provisional application No. 60/396,390, filed on Jul. 17, 2002.

(51) Int. Cl. G01B 7/30

(52) U.S. Cl. 324/207.25; 324/207.2; 324/207.21

(57) ABSTRACT

An apparatus and process for determining the absolute angular position of a rotating component. One or more linear position sensors, such as, for example, a Hall-Effect sensor, are placed near a degrading surface of a shaft or other rotating component. The rotation of the shaft varies the air gap between the sensor and the degrading surface thereby generating signals than can be processed to determine various operating parameters of the rotating shaft or component such as the absolute angular position of the rotating shaft, the rotation speed of the shaft, and the acceleration of the rotating shaft.

### CROSS-REFERENCE TO RELATED APPLICATIONS

This application is related to U.S. Provisional Patent Application No. 60/396,390 filed Jul. 17, 2002 from which priority is claimed.

### STATEMENT REGARDING FEDERALLY SPONSORED RESEARCH OR DEVELOPMENT

Not applicable.

### BACKGROUND OF THE INVENTION

1. Field of the Invention

This invention relates in general to sensing the position of a rotating component, and more particularly, to sensing the absolute rotational position of a rotating component.

2. Description of Related Art

Absolute angular position sensing is usually accomplished either through the use of a gray coded rotary device and several non-contacting sensors, such as in a typical industrial angular encoder, or through the use of a magnetic pattern in a target and one or more magnetic field detectors. Previous solutions are often bulky, expensive, and not well designed for harsh environments. Many patents have been filed regarding absolute angular position sensing. However, these devices tend to be large, costly, and relatively fragile.

Past angular position sensing designs use either a passive sensor or an active sensor for signal generation. The term “passive sensor” generally refers to a sensor that does not require power from the control system to operate. A variable reluctance sensor is an example of a passive sensor. The term “active sensor” generally refers to sensors that require power from the control system to operate. Hall-Effect sensors are an example of active sensors.

An example of previous rotational sensing designs is found in automotive applications. In automotive speed sensing applications, both active and passive sensors are used, however, most active sensors are used to provide zero speed sensing capabilities. The use of passive sensors has its disadvantages in that passive speed sensors cannot register a credible speed until their targets reach a minimum speed. In contrast, active speed sensors are capable of reading very slight movements in the targets. This makes them appropriate devices for anti-slip or traction control applications.

In each of these cases, the sensor is sensing the position of the rotating device by looking for well defined holes in the rotating device. For example, some automotive ignition timing systems find top dead center of a baseline piston by relying on a toothed wheel attached to the engine crankshaft or camshaft. These toothed wheel systems, however, rely more on an “on-off” signal from the sensor to determine that the rotating device is at a specific location or orientation. This method is unable to determine the absolute angular position of the rotating device at any point other than when the opening in a toothed wheel is at the sensor.

### SUMMARY OF THE INVENTION

The present invention resides in sensing the angular position of a rotating component to determine the absolute angular position of a rotating component at any point in the rotation of the rotating component. The present invention also resides in sensing other characteristics of the rotating component such as rotation speed, rotation direction, and angular acceleration.

More specifically, the present invention includes the use of at least one linear position sensor, such as a Hall-Effect sensor, to detect the angular position of a rotating component based on the analysis of the signal provided by the linear position sensor as it passes over a degrading surface on the rotating component. The invention allows for a simple, inexpensive form of absolute angular position sensing that is appropriate for use inside the protected environment of a bearing or bearing package, as well as, for use externally near rotating components. This device is extremely well suited for steering pivots, implement joints, booms, cranes, hoists, backhoes, front loaders, and almost all forms of mobile equipment.

The present invention also includes various alternative embodiments of the invention that include the ability to provide signals that allow the calculation of the speed of rotation of the rotating component and direction of rotation of the rotating component, as well as the rate of acceleration of the rotation of the rotating component.

Other objects and features of the present invention will be in part apparent and in part pointed out hereinafter.

### DESCRIPTION OF THE DRAWINGS

FIG. 1 is a diagram showing the relationship between a single sensor and a single degrading surface.

FIG. 2 is a side view showing a first embodiment of the present invention.

FIG. 3 is a side view showing a second embodiment of the present invention.

FIG. 4 is a perspective view of one embodiment of the degrading surface used in one embodiment of the present invention.

FIG. 5 is a perspective view of the present invention showing a combination of the first and second embodiments.

Corresponding reference characters indicate corresponding parts throughout the several views of the drawings.

### DETAILED DESCRIPTION OF THE INVENTION

While there are a number of embodiments of the present invention, the particular exemplary embodiment described herein includes determining the absolute angular position of a shaft in a bearing assembly by use of linear position sensors and degrading surfaces. Thus, in this embodiment, the rotating component is a shaft.

The phrase “absolute angular position” means that the device knows the angular position of the shaft as soon as power is applied to the device. No motion is required to allow the device to “find” a reference mark and count from the mark, as would be the case with a relative position sensor. The term “degrading surface” means a surface located near an linear position sensor wherein the surface is inclined in relation to the linear position sensor where such inclination varies the signal generated by the linear position sensor as the inclined surface moves past the detecting element of the linear position sensor to change the air gap between the inclined surface and the linear position sensor. The linear position sensor is therefore being used as a linear position sensor for the present invention. Additionally, the term “linear position sensor” means the sensor measures the straight line distance between the sensor and the degrading surface. The actual output signal of the sensor may be linear or nonlinear with respect to the distance measured.

It is important to note that the magnetic characteristic and the material composition of the degrading surface are dependent upon the type of linear position sensor used. For example, as used herein, a linear position sensor may be a magnetic sensor such as a Hall-Effect sensor, magnetoresistive sensor, or giant magnetoresistive with a back-biased magnet requires a ferromagnetic degrading surface. In another example, a magnetic sensor such as a Hall-Effect sensor, a magneto resistive sensor, or a giant magnetoresistive sensor without a back-biased magnet requires a magnetic degrading surface. In yet another example, use of an eddy current sensor does not require a back-biased magnet or a magnetic degrading surface for its operation, but does require that the degrading surface be made from either a ferromagnetic material of a non-ferromagnetic conductive material.

After the selection of the type of linear position sensor is made, and the magnetic characteristic and material composition of the degrading surface is selected, the present invention combines one or more of the constantly degrading surfaces and one or more of the linear position sensors. Each linear position sensor is positioned above one of the constantly degrading surfaces that have been located on a rotating component. As the rotating component rotates, the air gap between the degrading surface and the sensing element of the linear position sensor changes by either reducing or increasing in size. By placing the linear position sensor over such a constantly changing surface, the change in air gap will influence the change in signal output from the linear position sensor.

While the present invention may be incorporated into almost any application where the absolute angular position of a rotating component must be determined, one example of the present invention is shown herein as applied to a rotating shaft that is free to rotate within a bearing. Although the following description addresses many of the characteristics and requirements when the present invention is used in a rotating shaft and bearing combination, it is understood that the linear position sensors may be mounted in any manner, including those applications not including bearings, so long as the linear position sensor is capable of detecting the changes in the air gap between the linear position sensor and the degrading surface located on the rotating component.

In the present exemplary embodiment, FIG. 4 shows a degrading surface that has been machined into a rotating circular plate 1 that is generally circular in shape. The outer surface 2 of the plate 1 is spirally shaped with the major axis of the spiral coinciding with the rotating axis X of the plate. In this example, the spiral shaped outer surface 2 is the degrading surface. As used in the present embodiment, a linear position sensor would be positioned perpendicular to the spiral circumferential surface and the signal generated by the linear position sensor would vary in proportion to the air gap between the spiral outer surface and the sensing element of the linear position sensor element.

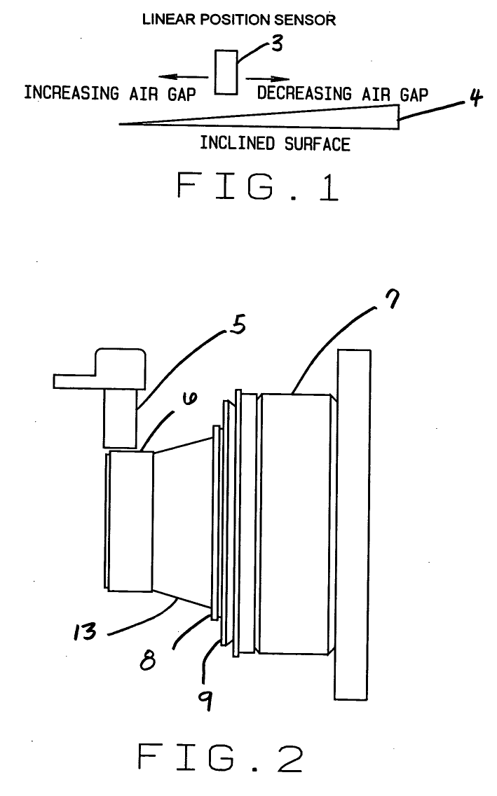

FIG. 1 provides a schematic representation of this action. Moving the sensor 3 to the right in relation to the inclined surface 4 will decrease the air gap, while moving the sensor 3 to the left will increase the air gap. This change in air gap will result in a change in the signal sent from the sensor 3. Thus, as the air gap changes, the sensor signal increases or decreases and this varying sensor signal is manipulated electronically to derive and represent the angular position of the device.

By wrapping the inclined surface 4 of FIG. 1 into a degrading surface on a rotating shaft located within a bearing, a target is created that may be placed in several axial or radial locations within a bearing and/or placed on a separate member on the rotating shaft. The effect of this wrapping of the inclined surface is the same as the relationship shown in FIG. 1 As long as the sensor can be easily attached to a stationary member that is not moving relative to the degrading surface, the device can easily function as an absolute angular encoder for movements less than 360 degrees.

It is noted, however, that a singular surface and sensor cannot distinguish between the “step” and other portions of the spiraled surface. Using multiple sensors on a single surface can easily account for this action. This happens because at least one signal would be generated from at least one linear position sensor that would not be positioned over the step in the spiral degrading surface. Alternatively, more than one surface may be used as described below to remove the 360-degree restriction. Either way, the combination of two signals from one or two surfaces eliminates most problems associated with moving certain types of geometric surfaces near a linear position sensor.

The degrading surface may simply be machined into the ring of a bearing with a linearized, temperature corrected, Hall-Effect element placed over the ring of the bearing. The degrading surface can be manufactured in any non-load carrying surface of the bearing or rotating component, or the degrading surface can be added by pressing a ring having a degraded surface onto the bearing. By way of example, typical places for locating the degrading surface within the present exemplary embodiment include bearing face OD's (a radial degradation surface), bearing face ends (an axial degradation surface), and bearing seals (both an axial or radial degradation surface). Other embodiments of the present invention would have at least one linear position sensor located on brackets near at least one degrading surface of a rotating component.

In the present embodiment, however, any of the above mounting techniques may be applied to either the inside or the outside of a bearing. However, packaging the concept inside a bearing provides a load carrying structure that is already needed in the application with the ability to provide crucial information to the control system. At the same time, the relatively delicate linear position sensor is protected by the bearing's structure.

FIG. 2 shows the details of an exemplary embodiment of the present invention as applied to a shaft rotating within a bearing. More specifically, a sensor 5 is fixedly mounted near a radial surface 6 of the rotating group of a bearing 7. In this embodiment, the radial surface 6 has been designed to include a degrading surface and the radial surface is on an extension 13 added to the bearing. As the radial surface 6 rotates, the degrading surface of the radial surface 6 causes the air gap between the radial surface 6 and the sensor 5 to either increase or decrease. The sensing of the absolute position of the rotating radial surface 6 is determined by using the varying signal generated by the sensor 5 as the degrading surface 6 on the outside circumferential surface passes near the sensor 5. This is an example of a radial read and is appropriate for incorporation in packaged bearing concepts.

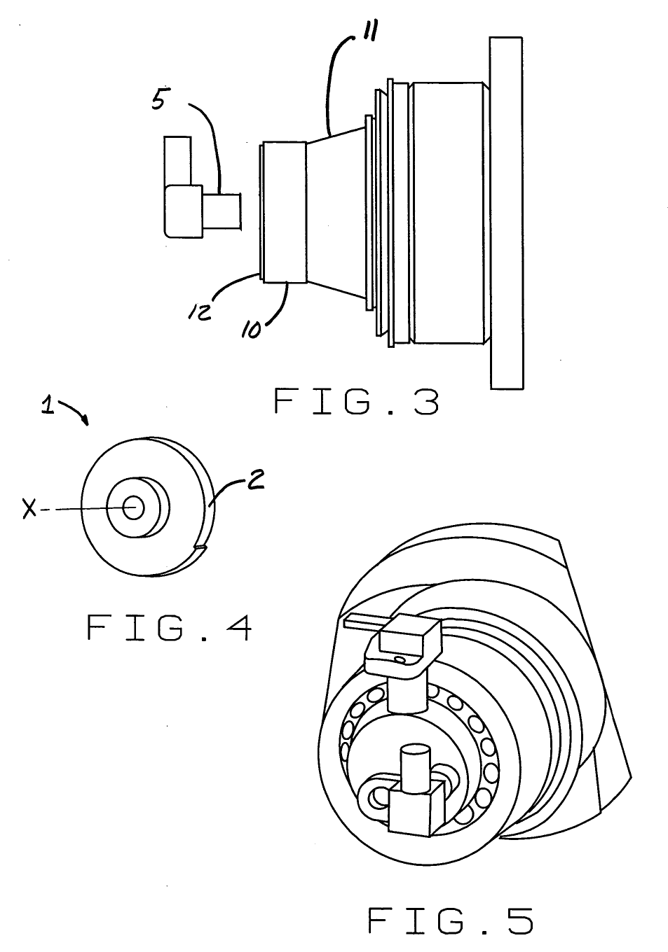

FIG. 3 shows an alternate version of the present exemplary embodiment of the present invention where a single sensor 5 is located near an end cap or end portion 10 of the rotating shaft 11 or a component fixed and rotating in unison with the rotating shaft 11. This is an example of an axial read and demonstrates that the degrading surface 12 can be incorporated directly into the front or back faces of a shaft or a bearing component.

In some situations, it may be necessary to increase accuracy. In that case, variations of the above embodiments can be applied. A first variation includes the ability to sense temperature. Combined Hall-Effect/temperature sensors are readily available and can be used to compensate for temperature variations. These sensors, which may be internally linearized or which may provide the temperature output, can be used to increase the accuracy. Alternatively, accuracy can be increased by combining the linear position sensor with a separate temperature probe and then electronically compensating for the temperature during the derivation of the absolute angular position or other characteristic of the rotating component. In this way, the temperature reading is taken into account for any variation in air gap due to temperature changes.

In an alternate embodiment of the present invention, accuracy is increased by using two surfaces and two linear position sensors. The degrading surfaces are oriented so that as one increases the other decreases. Then, by combining the outputs in the following formula, the overall output accuracy and error tolerances are improved.

P=(A−B)/(A+B)

Where:

P=the position of the rotating component;

A=the position of the rotating component as determined by a first linear position sensor; and

B=the position of the rotating component as determined by a second linear position sensor.

If the first sensor and degrading surface provide a channel A signal and the second sensor and surface provide a channel B signal, then once the two have a similar full range output, it is appropriate to use the above formula to determine the absolute angular position of the rotating component. This will increase accuracy of the angular location and will aid in reducing any possible variations caused by slight dynamic changes in the air gap. In fact, because air gap is critical, movement between the sensor and the detection surface must be minimized. Thus, it is also desirable for the bearing to be in preload to optimize the accuracy of the system.

While the above exemplary embodiment uses degrading surfaces that can be located on the rotating shaft, the annular space between the roller sets in assemblies, extended faces (cups and cones) for radial or axial reads, and seals within which this sensing concept is integrated are all possible embodiments of the present invention. However, the same situation applies to external members of rotating shaft and bearing assembly. The bearing provides a rigid sealed structure and possibly the best environment, although a similar approach is feasible outside of the bearing as well.

In a derivation of this embodiment, a notch is included in the circular ring such that the notch is aligned with the step in the constantly degrading ring. The notch can be used as a reference point to allow for a full 360 degrees of motion. In other embodiments where less than 360 degrees of movement is required, the degrading surface may only cover an area slightly larger than the swing required. This allows the maximum drop to be incorporated into the physical change in air gap, thus maximizing the sensor's accuracy.

Finally, it is noted that in yet other embodiments of the present invention, characteristics other than absolute angular position are achievable. For example, direction of rotation and speed of rotation are also derivable from the signals generated by the sensors of the present invention. The direction of rotation is simply a matter of determining if the air gap is increasing or decreasing. Similarly, accelerations in rotational speed can also be derived by determining how quickly the air gap is changing.

FIG. 5 shows another embodiment of the present invention that combines the first and second exemplary embodiments into a single exemplary embodiment.

While the above exemplary embodiments of the present invention rely upon a Hall-Effect sensor as the linear position sensor, it is understood that other types of linear position sensors such as capacitive sensors, eddy current sensors, inductive sensors, magnetic sensors, ultrasonic sensors, or optical sensors may be used so long as the sensor selected is capable of providing at least one signal corresponding to changes in the air gap between the linear position sensor chosen and the degrading surface of the rotating component.

It will be appreciated that aspects of the embodiments of the present invention as shown may be combined in various combinations to generate other alternative embodiments while staying within the scope of the present invention. Additionally, while the above description shows various embodiments of the present invention, it will be clear that the present invention may be otherwise easily adapted to fit any configuration where the ability to determine the absolute angular position of a rotating component is needed.

In view of the above, it will be seen that the several objects of the invention are achieved and other advantageous results attained. As various changes could be made in the above constructions without departing from the scope of the invention, it is intended that all matter contained in the above description or shown in the accompanying drawings shall be interpreted as illustrative and not in a limiting sense.

What is claimed is:

1. The combination comprising at least one linear position sensor and at least one degrading surface wherein at least one signal generated by the at least one linear position sensor is used to derive an absolute angular position of a rotating component.

2. The combination of claim 1 wherein the at least one linear position sensor is one of either a Hall-Effect sensor, a magnetoresistive sensor, a giant magnetoresistive sensor, a capacitive sensor, an eddy current sensor, an inductive sensor, a magnetic sensor, an ultrasonic sensor, or an optical sensor.

3. The combination of claim 2 wherein the degrading surface is a radial outer surface located on the rotating component.

4. The combination of claim 3 wherein the at least one signal generated by the at least one linear position sensor is used to derive at least one of the speed of rotation of the rotating component, the amount of angular acceleration of the speed of the rotating component, or the direction of rotation of the rotating component.

5. The combination of claim 2 wherein the degrading surface is an axial face located on the rotating component.

6. The combination of claim 5 wherein the signal generated by the at least one linear position sensor is used to derive at least one of the speed of rotation of the rotating component, the amount of angular acceleration of the speed of the rotating component, or the direction of rotation of the rotating component.

7. The combination of claim 2 wherein there is a first linear position sensor, a first degrading surface, a second linear position sensor, and a second degrading surface, the incline of the first degrading surface being opposite to the incline of the second degrading surface, the first linear position sensor being located to detect a change in a first air gap between the first linear position sensor and the first degrading surface as the rotating component is rotated, and the second linear position sensor being located to detect a change in a second air gap between the second linear position sensor and the second degrading surface as the rotating component is rotated.

8. The combination of claim 7 wherein the first linear position sensor generates a first signal and the second linear position sensor generates a second signal and wherein the position of the rotating component is derived from the formula
P=(A−B)/(A+B)
Where:
P=the position of the rotating component;
A=the position of the rotating component as derived from the first signal, and
B=the position of the rotating component as derived by the second signal.

9. The combination of claim 8 further comprising a notch in a circular ring, wherein the notch is aligned with the step in the degrading surface such that the notch is used as a reference point to allow for a 360 degree range of motion of the rotating component.

10. The combination of claim 8 wherein the at least one linear position sensor includes an ability to generate at least one signal corresponding to a temperature.

11. The combination of claim 2 wherein the degrading surface covers less than the entire 360 degree surface of a rotating component.

12. The combination of claim 2 wherein the at least one degrading surface is made from material that is at least one of ferromagnetic, magnetic, conductive, or non-ferromagnetic.

13. A method of determining the absolute angular position of a rotating component comprising the steps of:
a. providing at least one linear position sensor;
b. providing at least one rotating component having at least one degrading surface;
c. positioning the at least one linear position sensor such that an air gap exists between the at least one linear position sensor and the at least one degrading surface;
d. detecting at least one signal from the at least one linear position sensor, the at least one signal being responsive to changes in the air gap between the at least one linear position sensor and the at least one degrading surface; and
e. using the at least one signal to derive the absolute angular position of the rotating component.

14. The method of claim 13 wherein the at least one linear position sensor is one of either a Hall-Effect sensor, a magnetoresistive sensor, a giant magnetoresistive sensor, a capacitive sensor, an eddy current sensor, an inductive sensor, a magnetic sensor, an ultrasonic sensor, or optical sensor.

15. The method of claim 14 wherein the degrading surface is a radial outer surface of the rotating component.

16. The method of claim 15 wherein the at least one signal generated by the at least one linear position sensor is used to derive at least one of the speed of rotation of the rotating component, the amount of angular acceleration of the speed of the rotating component, or the direction of rotation of the rotating component.

17. The method of claim 14 wherein the degrading surface is an axial face of the rotating component.

18. The method of claim 17 wherein the signal generated by the at least one linear position sensor is used to derive at least one of the speed of rotation of the rotating component, the amount of angular acceleration of the speed of the rotating component, or the direction of rotation of the rotating component.

19. The combination of claim 14 wherein there is a first linear position sensor, a first degrading surface, a second linear position sensor, and a second degrading surface, the incline of the first degrading surface being opposite to the incline of the second degrading surface, the first linear position sensor located to detected a change in a first air gap between the first linear position sensor and the first degrading surface as the rotating component is rotated, and the second linear position sensor being located to detect a change in a second air gap between the second linear position sensor and the second degrading surface as the rotating component is rotated.

20. The method of claim 19 wherein the first linear position sensor generates a first signal A and the second linear position sensor generates a second signal B wherein the position of the rotating component is derived from the formula
P=(A−B)/(A+B)
Where:
P=the position of the rotating component;
A=the position of the rotating component as derived from the first signal, and
B=the position of the rotating component as derived by the second signal.

21. The method of claim 14 further comprising a notch in a circular ring, wherein the notch is aligned with the step in the degrading surface such that the notch is used as a reference point to allow for a 360 degree range of motion of the rotating component.

22. The method of claim 14 wherein the at least one linear position sensor includes an ability to generate a signal corresponding to a temperature.

23. The method of claim 14 wherein the degrading surface covers less than the entire 360 degree surface of a rotating component.

24. The method of claim 14 wherein the at least one degrading surface is made from material that is at least one of ferromagnetic, magnetic, conductive, or non-ferromagnetic.
